(19) United States
(12) Patent Application Publication
(10) Pub. No.: US 2011/0051544 A1
(43) Pub. Date: Mar. 3, 2011

(54) DEVICE FOR MIXING AND/OR KNEADING FOOD PRODUCTS

(75) Inventors: Gilis Anne Maria Victor Lekner, Berg En Terblijt (NL); Marinus Arie Van Praag, Bunde (NL)

(73) Assignee: SOTEC BEHEER TWEE B.V., Maastricht (NL)

(21) Appl. No.: 12/865,029

(22) PCT Filed: Jan. 26, 2009
(86) PCT No.: PCT/NL09/00015

§ 371 Date: Nov. 16, 2010

(30) Foreign Application Priority Data
Jan. 29, 2008 (NL) 1034970

(51) Int. Cl. B01F 7/02; B01F 15/02

(52) U.S. Cl. 366/76.5; 366/79; 366/84; 366/80; 366/77

(57) ABSTRACT

A device for mixing and/or kneading food products. The device includes a container having an inlet, an outlet, and at least one rotary shaft extending substantially in a longitudinal direction of the container. The at least one rotary shaft includes at least one tool, the at least one tool including at least one bar connected to the at least one rotary shaft via spacers. The at least one rotary shaft further includes an operative area to continuously mix and/or knead the food products, the operative area extending in a longitudinal direction of the at least one rotary shaft.

This application is a national stage of International Application PCT/NL2009/000015, filed Jan. 26, 2009 and claims benefit of and priority to Netherlands Patent Application No. 1034970, filed Jan. 29, 2008, the content of which Applications are incorporated by reference herein.

### BACKGROUND AND SUMMARY

The present disclosure relates to a device for mixing and/or kneading food products. The device is provided with at least one container having an inlet, an outlet as well as at least one rotary shaft extending substantially in the longitudinal direction of the container. The shaft is provided with at least one tool, which tool comprises at least one bar which is connected to the shaft via spacers. The shaft comprises an operative area for continuous mixing and/or kneading of food products, which extends in the longitudinal direction of the shaft.

The present disclosure further relates to a method for mixing and/or kneading food products in a container. The food products are supplied from an inlet to a rotary shaft fitted with a tool for mixing and/or kneading the food products. The food products are subsequently discharged through an outlet.

Such a device and method suitable for kneading and/or mixing food products are known from NL-1029273. The device comprises a container, in which two counter-rotating shafts are disposed side by side, which shafts are fitted with tools in the form of bars that helically surround the shafts. In the container, the dough is transported from the inlet to the outlet in use. The rate of movement of the products in the container being determined by the shape of the tool and the tilting of the container, among other things, so that the force of gravity can contribute positively towards increasing the rate of movement of the food products in the container.

Although excellent results are obtained with the known device, tilting the container by means of the lifting mechanism for the purpose of influencing the rate of movement of the food products in the container takes energy. In addition, such a lifting mechanism requires periodic maintenance.

The present disclosure relates to providing an improved device for mixing and/or kneading food products.

This is accomplished with the device, according to the present disclosure, in that the inlet and also the outlet extend in longitudinal direction substantially over the operative area of the shaft between the inlet and the outlet.

Using such a device, it is possible to control the quality of the mixing and/or kneading process of the food products in a container, for example by having the shafts rotate at a higher or lower speed, without this necessarily having any effect on the amount produced by means of the device. Unlike known devices, the rate of movement of the food products between the inlet and the outlet is hardly influenced by the shafts fitted with the tool, because the movement of the food products in the container will, according to the present disclosure, take place mainly in vertical direction and hardly in the horizontal direction. The rate of the vertical movement between the inlet and the outlet is mainly determined by gravity. By using such a configuration of the inlet and the outlet, a maximum contribution of the force of gravity to the rate of movement is realized without energy-consuming devices being required. The inlet opening extending in the longitudinal direction evenly distributes the food products from, for example, a distributor hopper over the operative area of the tool that extends substantially identically in the longitudinal direction. In this way, the entire capacity of the tool extending in longitudinal direction is utilized in an efficient manner and all the food products being supplied are mixed or kneaded in the operative area of the shaft. The food products are discharged from the container through the outlet in the same efficient manner.

The device according to the present disclosure can furthermore be used in a very flexible manner for mixing and/or kneading, in short succession, products that require different mixing and/or kneading treatments.

An embodiment of the present disclosure includes a virtual vertical that extends both through the inlet and through the outlet.

Since the same vertical crosses both the inlet and the outlet, the openings defined by the inlet and the outlet are vertically aligned. The term “virtual vertical” is understood to mean a line extending in the direction of gravity.

Disposed on a shaft between the inlet and the outlet is a tool in the form of at least one bar. The tool is suitable, for example, for kneading food products, the term “kneading” being understood to mean the putting of energy and gas into the food products to be processed, for example, by way of shearing forces being generated by way of the bars of the tools, but also between the bars and the walls of the container. For kneading, the bar, for example, extends over practically the entire length of the shaft, so that the forces will be evenly distributed over the shaft. According to another embodiment, however, several bars are arranged in line behind each other, or U-shaped brackets are mounted to the shaft, in which case the bridge portion of the U-shaped brackets forms the bar and the legs thereof form the spacers.

The device according to the present disclosure is suitable, for example, for kneading a viscous mixture by use of the tool, while the rotating bars can also mix the food products present in the container. The central axis of the inlet is located, for example, substantially on the same vertical as the central axis of the outlet.

The term “food products” as used herein is further understood to refer to food components and additives that are common in the food industry.

Yet another embodiment of the device according to the present disclosure includes the fact that the dimension of the inlet and/or the outlet, for example, the transverse dimension, can be variably adjusted.

Varying the dimension of the inlet and/or the outlet makes it possible to control the amount per unit time that is supplied to the container and/or the amount per unit time that is discharged from the container, and thus the residence time and the volume of the food products in the container. If it is empirically determined that the food products need to be mixed and/or kneaded longer to obtain the desired quality, the dimension of, for example, the outlet can be temporarily reduced in comparison to the inlet, so that temporarily more food products will be supplied to the container through the inlet than discharged through the outlet. In this way, the container will become fuller and the food products will have a longer average stay in the container, such that the food products will be mixed and/or kneaded longer. Conversely, the outlet may be enlarged temporarily in comparison with the inlet. Such an inlet and/or outlet whose dimension can be temporarily varied is especially advantageous in the case of a device, according to the present disclosure, for continuous mixing and/or kneading of food products. That is because a temporary change of the dimensions makes it possible to control the residence time of the food products and thus the quality of the kneaded and/or mixed food products.

The dimension of the inlet and the outlet in the longitudinal direction may be, for example, constant, while the width of the inlet and outlet openings is varied. Thus, it is ensured at the inlet that the food products will be evenly distributed over the tools extending in the longitudinal direction and that uniformly mixed/kneaded food products can be discharged at the outlet.

As a result of the corresponding dimensions of the inlet and the outlet, the amount of the food products to be treated that is supplied to the container per unit time may, for example, be substantially the same as or exhibit a fixed proportion in relation to the amount to be discharged per unit time, so that the container can be operated continuously, thereby providing a device for continuous mixing and/for kneading of food products.

Another embodiment of the device according to the present disclosure includes the fact that the outlet of the container is provided with two counter-rotatable discharge rollers extending parallel to the shafts, between which a discharge gap is present.

The food products that have been treated in the container are uniformly discharged from the container by way of such discharge rollers. In addition, the discharge rate of the treated food products through the outlet can be controlled in dependence on the speed of rotation of the discharge rollers. Furthermore, the gases contained in the food products, which partially determine the quality of the food products to be treated with the tool, are uniformly distributed by the discharge rollers. The food products are additionally stretched by the counter-rotating discharge rollers, which is normally a separate operation, thereby rendering the device according to the present disclosure more efficient and thus more economical. The discharge rollers are counter-rotating, with the discharge roller located to the right of the discharge gap rotating in anti-clockwise direction and the discharge roller located to the left of the discharge rotating in clockwise direction.

It is within the scope of the present disclosure that the devices may include only one rotatable discharge roller extending parallel to the shaft, in which case a discharge gap will be present between a wall of the container and said discharge roller.

Yet another embodiment of the device according to the present disclosure includes the fact that the discharge gap is variably adjustable by moving the discharge rollers with respect to each other or by moving the discharge roller with respect to the wall.

In addition to adjusting the speed of rotation, it is possible to adjust the amount to be discharged per unit time, and thus the residence time of the food products in the container, by varying the outlet opening formed by the discharge gap by way of the variably adjustable discharge gap. The gap width of the discharge gap can, for example, be varied by moving the centers or axes of the discharge rollers relative to each other. Furthermore, it is possible to adjust the thickness of the layer of food products produced between the discharge rollers to the desired thickness in a simple manner by adjusting the gap width. Such a possibility to adjust the thickness of the layer of food products may be advantageous, for example, in connection with processes that take place after the food products have left the device, according to the present disclosure.

Another embodiment of the device according to the present disclosure includes the fact that the inlet of the container is provided with two counter-rotatable supply rollers extending parallel to the shafts, between which a supply gap is present.

To prevent an uneven supply of food products into the container, the container inlet is fitted with supply rollers, which evenly distribute the food products to be treated in the longitudinal direction of the tool. It is also possible to set the supply rate of the food products into the container to a desired supply rate in a simple manner by controlling the speed of rotation of the supply rollers. Furthermore, a first mixing and/or kneading treatment takes place by way of a compressive force being exerted on the food products by the supply rollers, wherein also the gases contained in the food products can be distributed more uniformly. The supply rollers are counter-rotatable, for example, in a similar manner as the discharge rollers. A supply rate which can be varied by the supply rollers and/or a discharge rate which can be varied by the discharge rollers may be advantageous in the case of a device for continuous mixing and/or kneading of food products. That is because it is possible to control the residence time of the food products in the container via a temporary change in said rates, thereby making it possible to control the quality of the kneaded and/or a mixed food products. According to another embodiment of the present disclosure, the device comprises only one rotatable supply roller extending parallel to the shaft, in which case a supply gap will be present between the supply roller and a wall of the container.

Yet another embodiment of the device according to the present disclosure includes the fact that the supply gap is variably adjustable by moving the supply rollers with respect to each other or by moving the supply roller with respect to the wall.

The dimension of the inlet opening for the food products formed by the supply gap can be varied by the supply roller(s), thus making it possible to set a desired amount to be supplied per unit time. The gap with of the discharge gap can be varied by moving the centers or axes of the rollers relative to each other.

With the device according to one or more embodiments of the present disclosure, it is also possible, for example, to keep the dimension of the supply gap constant and to vary the discharge gap temporarily, or vice versa. In this way it is possible to control the residence time of the food products, and thus the quality of the food products, in a simple manner while using a relatively simple device, in which only the width of the supply gap or of the discharge gap can be varied.

Yet another embodiment of the device according to the present disclosure includes the fact that the tool extends substantially parallel to the shaft.

When a tool extending substantially parallel to the shaft is used, the forces that are exerted on the tool in use will be substantially constant if the food products are uniformly distributed over the shaft. When the tool is loaded in such an even manner, the risk of fracture is zero, so that the tool will have a relatively long life. The spacing between the container wall and the bar or bars of the tool is, for example, comparatively small, and may, for example, be smaller than half the length of a spacer, so that the shearing forces being generated between the wall and the bar in use will be maximized, resulting in a better kneading result of the food products in the container.

Yet another embodiment of the device according to the present disclosure includes the fact that the shaft is provided with at least two tools disposed opposite each other, which tools and which shaft extending therebetween lie in a virtual plane.

In order to be able to process the food products in an effective way, each shaft is provided minimally with two tools. If the two tools and the shaft extending therebetween lie in a virtual plane, the shaft will be loaded symmetrically, resulting in less wear and a prolonged shaft life.

Yet another embodiment of the device according to the present disclosure includes the fact that the condition of the food products can be registered by using detection means, which detection means are connected to a control unit, by which the amount of energy to be input into the food products can be changed.

Said detection means may, for example, be temperature sensors or sensors that measure the energy supplied to the shafts or sensors that measure the viscosity or other quality characteristics of the food products which have been kneaded or mixed and/or are to be kneaded and/or mixed. When such detection means detect a variation that exceeds a threshold value, a control unit may respond thereto by changing the energy input into the food products to be kneaded/mixed.

The amount of energy to be input into the food products can be changed by adjusting the speed of rotation of the shaft(s) and/or the supply rollers and/or the discharge rollers. In this way the shearing forces generated between the tool and the container wall are increased or decreased, so that the food products will be kneaded better or less well.

The amount of energy to be input into the food products can also be changed by adapting the dimension of the inlet and/or the outlet. In this way the residence time of the food products is influenced, that is, prolonged or shortened. The inlet and/or the outlet may, for example, be formed by the supply gap and the discharge gap. If the outlet is formed by scrapers, the dimension of the outlet can also be varied by the scrapers.

Furthermore, the amount of energy to be input into the food products can be changed by adjusting the temperature of the supply rollers and/or the discharge rollers and/or the container walls.

To that end the rollers and/or the wall can be heatable.

When the above detection means are used, the occurrence of excessive variations is eliminated and a desired condition can be realized in the container via a closed loop and, concomitant therewith, the desired quality of the food products to be kneaded and/or mixed is thus obtained.

Yet another embodiment of the device according to the present disclosure includes the fact that the device may comprise a pre-mixer for providing a viscous mixture, which pre-mixer is disposed upstream of the container, while energy can be added to the viscous mixture in the container by way of the tool.

A pre-mixer may be a continuous mixer as is known, which normally includes a spiral or spiral-like tool comprising a large number of windings per unit length, for example more than 10 windings per meter, while the food products mixed by the pre-mixer are, for example, kneaded in the container of the device according to the present disclosure.

Yet another embodiment of the device according to the present disclosure includes the fact that the shaft or the shafts disposed side by side in the container form a first layer, above which and/or below which there is provided at least one further layer of at least two counter-rotatable shafts extending side by side substantially in the longitudinal direction of the container.

It is within the scope of the present disclosure to provide a number of layers of shafts provided with tools in dependence on the food products to be treated. Discharge rollers and/or supply rollers may be provided between the layers. In such a case, it may be, for example, that all layers are disposed between the discharge rollers and the supply rollers.

The present disclosure also relates to providing an improved method for mixing and/or kneading food products in an energetically and economically advantageous manner.

This may be accomplished with the method according to the present disclosure in that the food products are transported substantially in vertical direction from the inlet to the outlet under the influence of the force of gravity, during which transport the food products are mixed and/or kneaded in an operative area of the shaft between the inlet and the outlet.

Other aspects of the present disclosure will become apparent from the following descriptions when considered in conjunction with the accompanying drawings.

### BRIEF DESCRIPTION OF THE DRAWINGS

FIGS. 1a-c are perspective views of a device and a container according to the present disclosure.

FIGS. 2a and 2b are perspective views of an embodiment of the device and the container according to the present disclosure.

FIG. 3 is a schematic sectional view of another embodiment of a device according to the present disclosure.

### DETAILED DESCRIPTION

In the Figures, like parts are indicated by the same numerical designations.

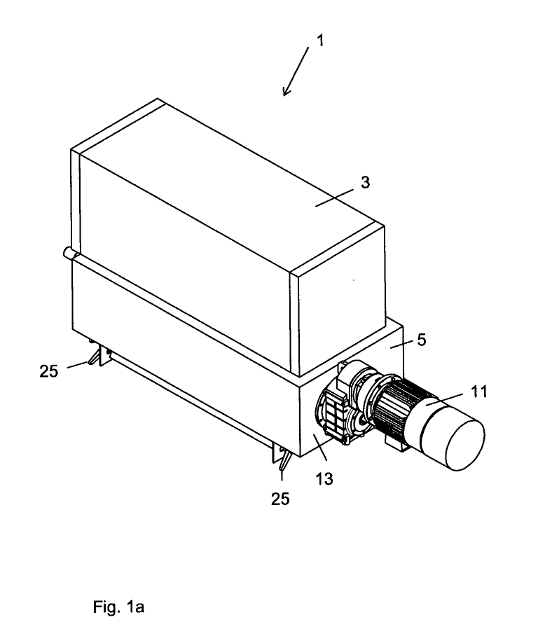

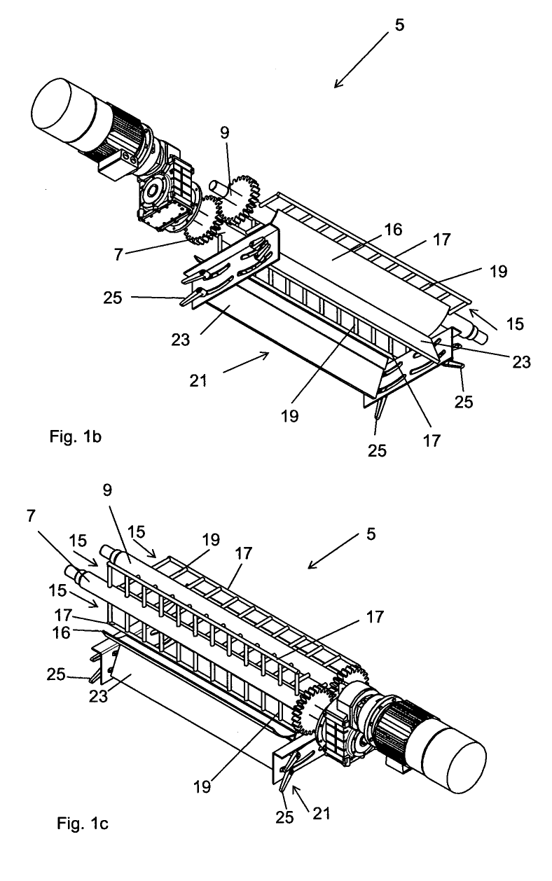

FIGS. 1a-c are perspective views of a device 1 and a container 5 according to the present disclosure. An outer wall 13 of the container 5 is shown in FIG. 1a but not shown in FIGS. 1b and 1c. The device 1 comprises a pre-mixer 3, which pre-mixer 3 may be a mixer configured in a manner which is known, but which may have an outlet (not shown) that extends in a longitudinal direction. The container 5 of the device 1, according to the present disclosure, comprises an inlet (not shown), an outlet (not shown), as well as at least two counter-rotatable shafts 7, 9 extending side by side substantially in the longitudinal direction of the container 5. The container 5 is provided with a driving mechanism 11. The shafts 7, 9 disposed in the container 5 can be rotated in opposite directions by the driving mechanism 11. In use, the shafts 7, 9, may, for example, rotate at a constant rotational speed.

The container 5 is provided with the inlet for filling the container 5 with the food products to be treated via the outlet of the pre-mixer 3. The outlet of the pre-mixer 3 is vertically aligned with the inlet of the container 5, and with an outlet of the container 5, which is vertically aligned with the inlet of the container 5, for discharging the treated food products from the container 5. The rotary shafts 7, 9 extend the entire length of the container 5. The container 5 is further provided with curved walls 16.

Each shaft 7, 9 is provided with a tool 15, which comprises two bars 17 extending parallel to the shaft 7, 9, which bars are connected to the shaft 7, 9 by spacers 19. The tool 15 extends in the longitudinal direction and defines an operative area, in which actual contact may take place between the bar 17 of the tool 15 and the food products present in the container 5. During rotation of the shafts 7, 9, the food products present in the container 5 are mainly kneaded by the bars 17. In use, the shafts 7, 9 rotate in opposite directions. The tools 15 on the two shafts 7, 9 comprise an overlapping area in the container 5 and are consequently oriented asymmetrically, in mirror image of each other, so that the tool 15 of the first shaft 7 will not come into contact with the tool 15 of the second shaft 9. In this illustrated embodiment, the asymmetrical orientation of the tools 15 is as follows: The tools 15 of the shaft 7 lie in a first virtual plane, while the two tools 15 of the shaft 9 lie in a second virtual plane, which first virtual plane of the shaft 7 extends transversely to the second virtual plane of the shaft 9. A tool 15 which is oriented in such a manner is excellently suitable for kneading the food products. Such a kneading process takes place, for example, between the longitudinally extending walls 16 of the container 5 and the longitudinally extending bars 17, and also between the bars 17 of the shaft 7 and the bars 17 of the shaft 9.

The container 5 that is shown in FIGS. 1a-c further comprises an outlet 21, which is bounded by scrapers 23 extending in the longitudinal direction of the container 5. Such scrapers 23 are adjustable via slotted holes by handles 25. The scrapers 23 can be fixed in the desired position by the handles 25. In use, the scrapers 23 abut against the curved walls 16. Food products that do not fit in the spaces between the curved walls 16 and the bars 17 while kneading takes place will be discharged via the outlet 21 by the scrapers 23.

In the container 5 according to the present disclosure, the outlet 21 is vertically aligned with the inlet of the container 5, in such a manner that the inlet, which extends substantially in the horizontal plane, is crossed by the same vertical as the outlet 21, which likewise extends substantially in a lower horizontal plane. The central axis of the inlet is located on the same vertical as the central axis of the outlet 21 of the container 5. It is important that both the outlet and the inlet of the container 5 can extend substantially in the longitudinal direction over the operative area of the shafts. The operative area is formed by the longitudinally extending tool 15.

The operation of the device 1 is as follows.

The food products, for example, ingredients for preparing a flour product, are mixed by the pre-mixer 3, and, for example, a viscous mixture is discharged through the outlet of the pre-mixer 3 to the inlet of the container 5. A vertical extends through the outlet of the pre-mixer 3, which vertical also extends through the inlet of the container 5. In the container 5, the batter prepared by the pre-mixer 3 is kneaded by the tool 15 mounted on the shafts 7, 9. Under the influence of the force of gravity, and by the scrapers 23, the food products kneaded by the tools 15 are discharged through the outlet 21 for possible further processing. Since a virtual vertical line, or the vertical, extends through the inlet as well as the outlet 21, the force of gravity has a maximum effect on the transport of the food products through the container 5 of the device 1, according to the present disclosure.

The scrapers 23 do not consume any energy in use and are economical as well as low-maintenance.

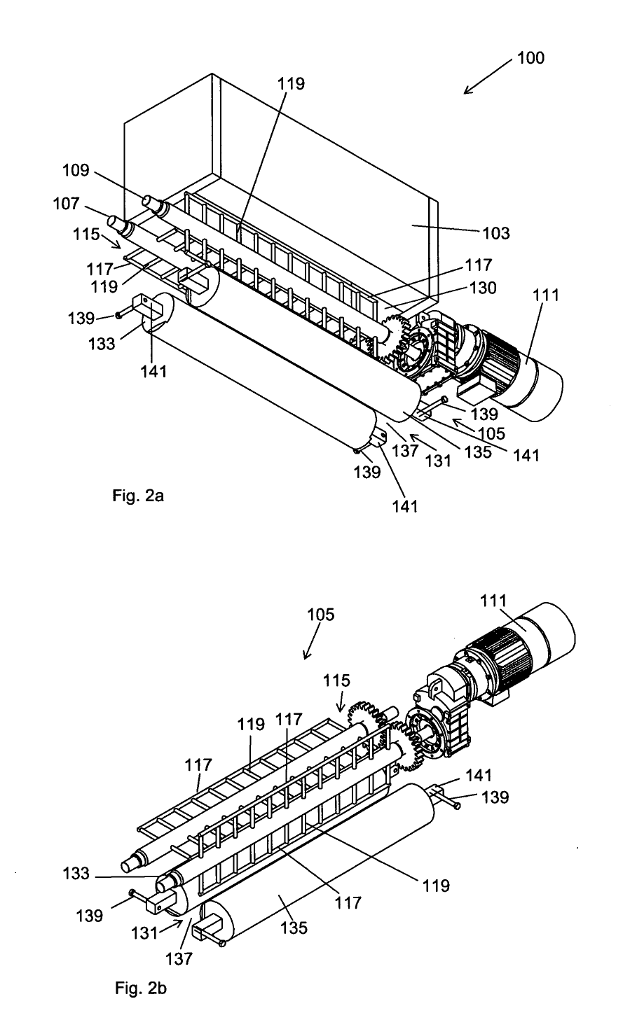

FIG. 2a is a perspective view of a device 100, according to the present disclosure. FIG. 2b is a perspective view of the container 105, from which the outer walls of the container 105 have been left out for the sake of clarity.

Parts corresponding to parts shown in FIGS. 1a-1c are indicated by the same numerals, but augmented by 100 in FIGS. 2a and 2b. Not all 100-level parts in FIGS. 2a-c are specifically identified herein but are shown in FIGS. 2a-c.

The container 105 comprises two shafts 107, 109, which are fitted with a tool 115, which is substantially identical as regards its shape and orientation to the tool 15 that is shown in FIGS. 1b and 1c.

The container 105 is provided with an inlet 130, as shown in FIG. 2a, which is aligned with an outlet of the pre-mixer 103.

The container 105 is further provided with an outlet 131, which outlet 131 comprises two counter-rotatable discharge rollers 133, 135 extending parallel to the shafts 107, 109, between which a discharge gap 137 extending in the longitudinal direction of the container 105 is present. The width of the discharge gap 137, that is, the spacing between the discharge rollers 133, 135, is variably adjustable by moving the discharge rollers 133, 135 with respect to each other by adjusting guides 139. The discharge rollers 133, 135 have ends 141, which are slidably movable over the adjusting guides 139 and which can be fixed in position thereon, so that the discharge gap 137 having a desired dimension is defined by the discharge rollers 133, 135.

The outlet 131 defined by the discharge gap 137, may, for example, have the same dimension as the inlet 130, but it is also possible to change the dimension if the conditions in the container require so. A virtual vertical (not shown) extends both through the inlet 130 and through the outlet 131, which means that the inlet 130 and the outlet 131 are vertically aligned.

The operation of the device 100 is substantially identical to the operation of the device 1, with a difference being that discharge rollers 133, 135 are provided instead of the scrapers 23. In the device 100, just as in the device 1, the force of gravity has a maximum effect on the transport through the container 105 on account of the vertical that extends both through the inlet 130 and through the outlet 131. In comparison with the scrapers 23 of the device 1, the discharge rollers 133, 135 provide an additional advantage that the gas present in the kneaded food products is distributed more uniformly. Moreover, the discharge rollers 133, 135 make it possible to obtain a layer of kneaded food products that has a uniform thickness. This is advantageous in connection with the further processing of the kneaded food products. Moreover, the thickness of the kneaded layer of food products can be adjusted by the discharge rollers 133, 135. In order to vary the amount to be discharged per unit time, it is possible, within the scope of the present disclosure, to vary the rotational speed of the discharge rollers 133, 135, but it is also possible to vary the width of the discharge gap 137 for the purpose of adjusting the amounts to be discharged per unit time. In this way, the residence time, and thus the quality of the food products, can be controlled in a simple manner.

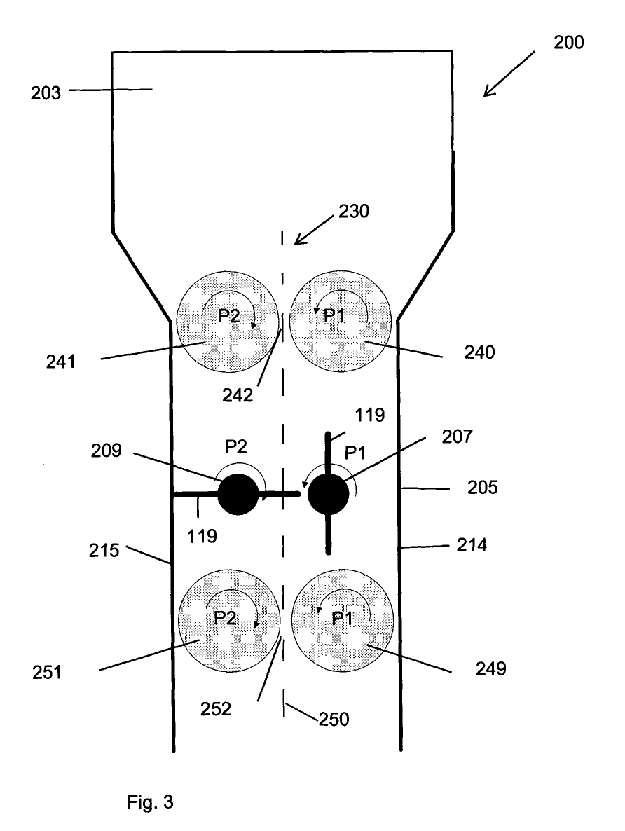

FIG. 3 is a schematic view of another embodiment of the device, designated as 200, according to the present disclosure.

The device 200 comprises a pre-mixer 203 and a container 205. An inlet 230 of the container 205 is provided with two counter-rotatable supply rollers 240, 241 extending parallel to the shafts 207, 209, between which supply rollers 240, 241 a supply gap 242 is present. The supply gap 242 between the supply rollers 240, 241 and also the speed of rotation of the supply rollers is variably adjustable in a similar manner as with the discharge rollers 133, 135.

The supply roller 240 located to the right of the supply gap 242 rotates in anti-clockwise direction P1, while the supply roller 241 located to the left of the supply gap 242 rotates in clockwise direction P2. Upon rotation of the supply rollers 240, 241 in their respective directions, the supply rollers 240, 241 comprise a transport function. As shown in FIG. 3, the discharge rollers 249, 251 rotate in the same directions, respectively, as the supply rollers 240, 241, respectively.

As illustrated by a dotted line in FIG. 3, the vertical 250 extends both through the supply gap 242 that forms at the inlet of the container 205 and through discharge gap 252 that forms the outlet of the container 205.

The supply gap 242 and the discharge gap 252 are variably adjustable as regards their width dimension by moving the respective supply rollers 240, 241 and discharge rollers 249, 251 relative to each other. Furthermore, the speed of rotation of the supply rollers 240, 241 and the discharge rollers 249, 251 is variably adjustable.

In spite of the fact that the shafts 207, 209 as shown, rotate in an identical, respective, manner as the rollers 240, 241, 249, 251, respectively, the shafts 207, 209 shafts do not need to comprise a transport function, and they may also rotate in the reverse manner of the illustrated manner of rotation between walls 214, 215 of the container 205.

An additional advantage of the supply gap 242 is that the food products from the pre-mixer 203 are evenly distributed over the longitudinally extending tool. In addition, a first mixing/kneading treatment takes place as a result of the compression between the supply rollers 240, 241.

The container 5 may, according to the present disclosure, additionally be provided with an air supply means (not shown) for supplying conditioned air in, for example, a controlled amount and having a controlled moisture content, composition and temperature.

The device, according to the present disclosure, may furthermore be provided with detection means which are known. By such detection means, the quality of the food products can be directly or indirectly determined. Such detection means may be connected, via a closed loop, to a control unit by which the speed of rotation of the shaft(s) 7, 9, 107, 109, 207, 209 and/or the supply rollers 240, 241 and/or the discharge rollers 133, 135, 249 and 251 can be adjusted. Or, by which the dimension of the supply gap 242 and/or the discharge gap 252 or the space between the scraper 23 can be adjusted. Or, by which the temperature of the supply rollers and/or the discharge rollers and/or the container walls can be adjusted.

The supply rollers 240, 241 and the discharge rollers 133, 135, 249, 251 may be profiled and be heatable or coolable. In addition, a liquid can be forcibly introduced into the food products one or more of the rollers, if desired. According to the present disclosure, two rollers defining a gap may have mutually different diameters.

It is within the scope of the present disclosure to use a metering unit instead of a pre-mixer.

Although the present disclosure has been described and illustrated in detail, it is to be clearly understood that this is done by way of illustration and example only and is not to be taken by way of limitation. The scope of the present disclosure is to be limited only by the terms of the appended claims.

1-23. (canceled)

24. A device for mixing and/or kneading food products, the device comprising:
a container having an inlet, an outlet, and at least one rotary shaft extending substantially in a longitudinal direction of the container;
the at least one rotary shaft includes at least one tool, the at least one tool including at least one bar connected to the at least one rotary shaft via spacers, and the at least one rotary shaft further including an operative area to continuously mix and/or knead the food products, the operative area extending in a longitudinal direction of the at least one rotary shaft, and
wherein the inlet and the outlet extend in the longitudinal direction over the operative area of the at least one rotary shaft which operative area extends between the inlet and the outlet.

25. The device according to claim 24, wherein a virtual vertical extends both through the inlet and through the outlet.

26. The device according to claim 24, wherein a transverse dimension of the inlet or the outlet, is variably adjustable.

27. The device according to claim 24, wherein a maximum dimension of the outlet substantially corresponds to a maximum dimension of the inlet.

28. The device according to claim 24, wherein the at least one rotary shaft is two rotary shafts and further comprises at least two counter-rotatable discharge rollers extending parallel to the rotary shafts, and between which discharge rollers is a discharge gap.

29. The device according to claim 27, wherein the discharge gap is variably adjustable by moving the discharge rollers with respect to each other.

30. The device according to claim 28, further comprising at least two counter-rotatable supply rollers extending parallel to the rotary shafts, and between which supply rollers a supply gap is present.

31. The device according to claim 30, wherein the supply gap is variably adjustable by moving the supply rollers with respect to each other.

32. The device according to claim 24, further comprising scrapers for scraping the food products from the at least one tool.

33. The device according to claim 28, wherein the outlet of the container is formed by the discharge gap.

34. The device according to claim 24, wherein the outlet of the container extends between two scrapers.

35. The device according to claim 24, wherein the at least one tool extends substantially parallel to the at least one rotary shaft.

36. The device according to claim 24, further comprising at least two tools disposed opposite each other, which tools and which at least one rotary shaft extending therebetween lie in a virtual plane.

37. The device according to claim 24, further comprising a pre-mixer for providing a viscous mixture, which pre-mixer is disposed upstream of the container, while energy is added to the viscous mixture in the container by the at least one tool.

38. The device according to claim 24, wherein the at least one rotary shaft includes two rotary shafts disposed side by side in the container to form a first layer, and above which first layer or below which first layer is at least one further layer of at least two counter-rotatable shafts extending side by side substantially in the longitudinal direction of the container.

39. A method for mixing and/or kneading food products in a container, the method comprising the steps of:
providing a container having an inlet, an outlet, and a rotary shaft fitted with a tool for the mixing and/or kneading of the food products;
supplying the food products via the inlet to the rotary shaft
transporting the food products substantially in a vertical direction from the inlet to the outlet under influence of the force of gravity, and during which transport the food products are mixed and/or kneaded in an operative area of the rotary shift between the inlet and the outlet.

40. The device according to claim 28, wherein the discharge gap is variably adjustable by moving the discharge rollers with respect to a wall of the container.

41. The device according to claim 30, wherein the supply gap is variably adjustable by moving the supply rollers with respect to a wall of the container.

42. The device according to claim 24, further comprising scrapers for scraping food products from at least one of a discharge roller and a supply roller.

43. The device according to claim 30, wherein the inlet of the container is formed by the supply gap.
